(19) United States
(12) Patent Application Publication
(10) Pub. No.: US 2010/0200643 A1
(43) Pub. Date: Aug. 12, 2010

(54) METHOD FOR PRODUCING ELECTRONIC PART UNIT

(75) Inventors: Nobuo Taketomi, Kawasaki (JP); Shigeo Iriguchi, Kawasaki (JP); Kazuhisa Tsunoi, Kawasaki (JP); Kiyoyuki Hatanaka, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/697,195

(22) Filed: Jan. 29, 2010

(30) Foreign Application Priority Data
Feb. 12, 2009 (JP) 2009-029463

(51) Int. Cl. B23K 31/02; B23K 1/00

(52) U.S. Cl. 228/175

(57) ABSTRACT

A method for producing an electronic part unit, the method includes: mounting a first electronic part on a first surface of a first substrate by reflow soldering; mounting a second electronic part on a second surface of a second substrate by reflow soldering; adhering a second surface of the first substrate to a first surface of a third substrate; and adhering a second surface of the second substrate to a second surface of the third substrate.

### CROSS-REFERENCE TO RELATED APPLICATION

This application is based upon and claims the benefit of priority of the prior Japanese Patent Application No. 2009-029463, filed on Feb. 12, 2009, the entire contents of which are incorporated herein by reference.

### FIELD

The embodiments discussed herein are related to methods for producing an electronic part unit.

### BACKGROUND

There is known a substrate on which electronic parts are mounted (see Japanese Unexamined Patent Publication No. 4-171993), and an electronic part unit equipped with such a substrate which has both surfaces where electronic parts are mounted. The electronic parts are mounted on the substrate by reflow soldering in some cases. The related techniques are disclosed in Japanese Unexamined Utility Model Application Publication No. 7-18479 and Japanese Unexamined Patent Publication No. 2006-203061.

In a case where the electronic parts are mounted on both surfaces of the substrate, the electronic part is mounted on a first surface of the substrate by reflow soldering, and then the electronic part is mounted on a second surface of the substrate by reflow soldering. Thus, the substrate is twice subjected to high-temperature environment.

Also, in a case where an error of some kind is raised by performing a test after the electronic part is mounted on each surface of the substrate, the electronic part may be removed and mounted again. In this case, the heat corresponding to the reflow is applied, when the electronic part is removed, and also when the electronic part is mounted again. Thus, the substrate is exposed to the high-temperature environment four times in total. Further, the electronic part which is first mounted on the substrate is also exposed to the high-temperature environment four times in total. Accordingly, it is difficult to employ a substrate or an electronic part with a low heat resistance in the electronic part unit in which the electronic parts are mounted on each surface of the substrate.

Further, the substrate includes an insulative layer made of a resin and a conductor layer made of a metal. Accordingly, when the substrate is exposed to the high-temperature environment, the substrate may be curved due to a difference between a thermal expansion coefficient of the insulative layer and that of the conductor layer. When the substrate is curved, for example, a plating plated on a through-hole may be cracked, or a clearance between the part electrode and the substrate may be enlarged to result in defective soldering. In addition, this may arise the problem that the substrate is dropped from a feed rail by narrowing the width of the substrate.

### SUMMARY

According to an aspect of the embodiments, a method for producing an electronic part unit, the method comprising: mounting a first electronic part on a first surface of a first substrate by reflow soldering; mounting a second electronic part on a second surface of a second substrate by reflow soldering; adhering a second surface of the first substrate to a first surface of a third substrate; and adhering a second surface of the second substrate to a second surface of the third substrate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view of an electronic part unit according to a first embodiment;

FIGS. 2A to 2E are explanatory views of a method for producing the electronic part unit;

FIG. 3 is an explanatory view of a check test of the electrical operation;

FIG. 4 is an explanatory view of the connection of a base substrate to a probe pin;

FIG. 5 is an explanatory view of a check test of the electrical operation;

FIG. 6 is an explanatory view of the connection of the base substrate, an inner substrate and a probe pin;

FIG. 7 is an explanatory view of an electronic part unit according to a second embodiment;

FIGS. 8A to 8D are explanatory views of an electronic part unit according to a third embodiment;

FIGS. 9A to 9C are explanatory views of the electronic part unit according to the third embodiment;

FIG. 10 is a explanatory view of the inner substrate;

FIGS. 11A and 11C are explanatory views of a method for producing an electronic part unit according to a fourth embodiment;

FIGS. 12A to 12C are explanatory views of a method for producing an electronic part unit according to a fifth embodiment;

FIGS. 13A to 13D are explanatory views of a method for producing an electronic part unit according to a sixth embodiment;

FIGS. 14A and 14B are explanatory views of the method for producing the electronic part unit according to the sixth embodiment;

FIGS. 15A and 15B are explanatory views of the method for producing the electronic part unit according to the sixth embodiment;

FIGS. 16A and 16B are explanatory views of an electronic part unit according to a seventh embodiment;

FIGS. 17A and 17B are explanatory views of an electronic part unit according to an eighth embodiment;

FIGS. 18A to 18C are explanatory views of a method for the adhesion of an electronic part unit according to a ninth embodiment;

FIGS. 19A and 19B are explanatory views of a method for adhesion of an electronic part unit according to a tenth embodiment; and

FIG. 20 is an explanatory view of an electronic part unit according to an eleventh embodiment.

### DESCRIPTION OF EMBODIMENTS

In the following, a description will be given of embodiments.

### First Embodiment

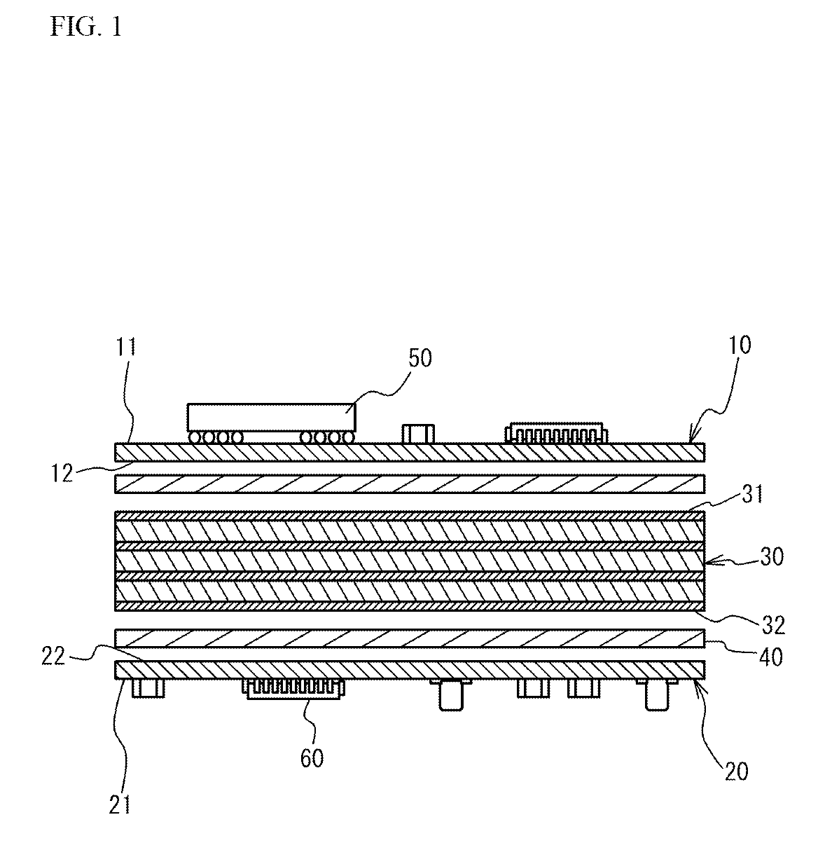

FIG. 1 is an explanatory view of an electronic part unit according to the first embodiment. The electronic part unit includes base substrates 10 and 20, an inner substrate 30, and adhesive members 40. Additionally, FIG. 1 illustrates members which are spaced from each other to facilitate the understanding of these arrangements. An electronic part 50 is mounted on a first surface 11 of the base substrate 10. An electronic part 60 is mounted on a first surface 21 of the base substrate 20. The base substrate 10 corresponds to a first base substrate. The base substrate 20 corresponds to a second base substrate. The electronic part 50 corresponds to a first electronic part. The electronic part 60 corresponds to a second electronic part.

The base substrates 10 and 20 each has a conductive wiring pattern formed on an insulting substrate. The inner substrate 30 is a multilayer substrate, and is made of plural layers of copper layers 38 and insulative layers 39. The copper layer 38 includes a wiring pattern and an electrode formed on a surface of the insulative layer 39. The insulative layer 39 is made of, for example, a polyimide resin or a glass epoxy resin, preferably, having a low coefficient of thermal expansion. The adhesive member 40, for example, has a sheet shape and its material may be made of a thermosetting resin or a prepreg. Preferably, the adhesive member 40 is hardened at about 120 degrees C.

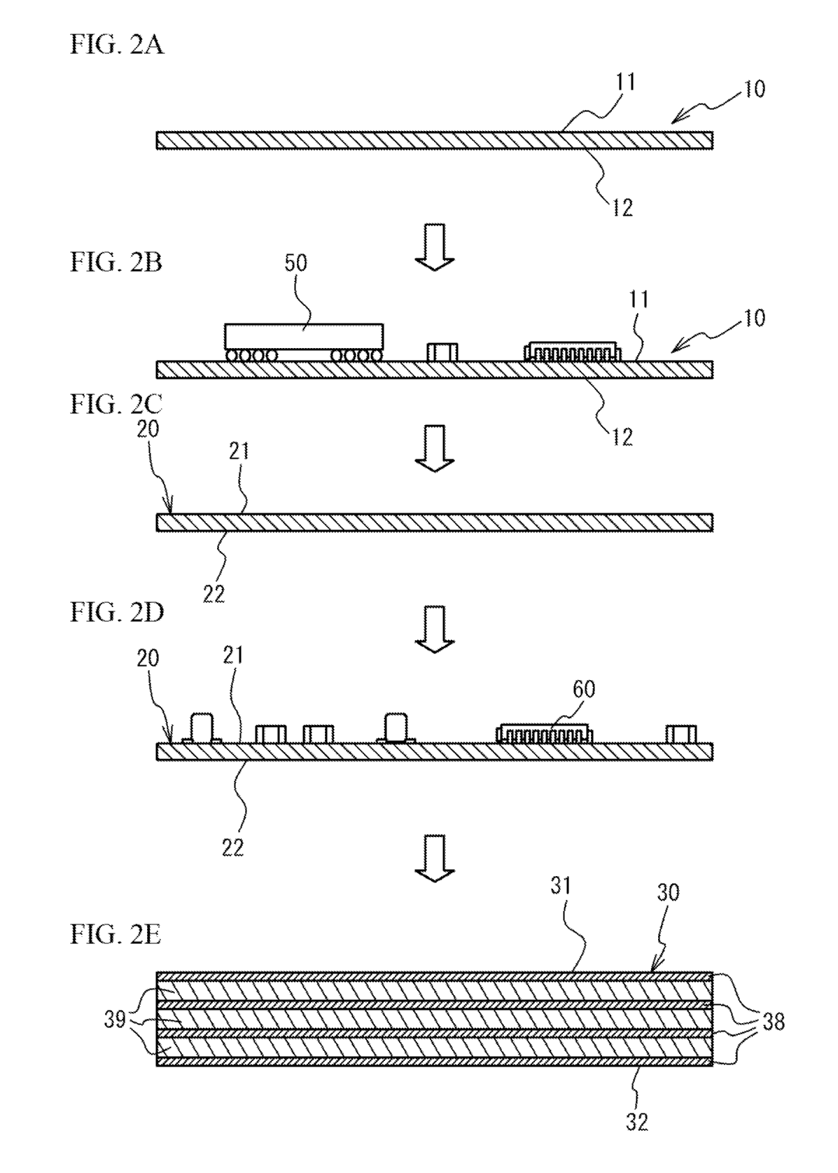

FIGS. 2A to 2E are explanatory views of a method for producing the electronic part unit. As illustrated in FIGS. 2A and 2B, the electronic part 50 is mounted on the first surface 11 of the base substrate 10 by reflow soldering. For example, in such a heat application, a maximum temperature is about 240 degrees C. A solder for connecting the electronic part 50 to the base substrate 10 is melted by reflow soldering. Then, the base substrate 10 and the electronic part 50 are electrically connected to each other by cooling the solder. The mounting of the electronic part 50 on the base substrate 10 corresponds to a first mounting step. Likewise, as illustrated in FIGS. 2C and 2D, the electronic part 60 is mounted on the first surface 21 of the base substrate 20. The mounting of the electronic part 60 on the base substrate 20 corresponds to a second mounting step.

Next, as illustrated in FIG. 2E, a second surface 12 of the base substrate 10 is adhered to a first surface 31 of the inner substrate 30 by the adhesive member 40. The temperature, when the adhesion is performed, is about 120 degrees C., which is lower than the temperature, when the reflow soldering is performed. The step where the base substrate 10 is adhered to the inner substrate 30 corresponds to a first adhesion step. Then, a second surface 22 of the base substrate 20 is adhered to a second surface 32 of the inner substrate 30 by the adhesive member 40. The step where the base substrate 20 is adhered to the inner substrate 30 corresponds to a second adhesion step. The electronic part unit is produced by these steps. In this way, the base substrates 10 and 20, and the electronic parts 50 and 60 are heated at 240 degrees C. only once, and are heated at 120 degrees C. only once. The inner substrate 30 is heated at 120 degrees C. only once. Accordingly, the heat influence is made smaller than a conventional method. Consequently, this suppresses a problem caused by performing reflow soldering at plural times.

Additionally, the electronic parts are not mounted on the second surface 12 of the base substrate 10 and on the second surface 22 of the base substrate 20. Therefore, the reflow soldering can be performed with the second surface 12 of the base substrate 10 and the second surface 22 of the base substrate 20 being supported on a support stage. This suppresses the base substrates 10 and 20 from being curved.

For example, in a case where the electronic parts are mounted on both surface of the substrate, the electronic parts are mounted on one surface by reflow soldering, and then the electronic parts are mounted on the other surface. In a case where the electronic parts are mounted on the other surface, the other surface has to be supported to face upwardly. Since the electronic parts are beforehand mounted on the other surface, the substrate is supported by inserting pins or the like into a clearance between the electronic parts. Thus, the supported area is small, whereby it is difficult to support the substrate with stably. To support one surface of the substrate, it is conceivable that the electronic parts mounted on one surface are supported. However, since the reflow soldering is performed for mounting the electronic parts on the other surface, the electronic parts beforehand mounted on one surface reach high temperatures. This may melt the solder connecting the electronic part to one surface of the substrate, and may result in the removal of the electronic part.

However, the electronic parts are mounted on only one surface of the base substrates 10 and 20, as described above, and the base substrates 10 and 20 are reflowed individually. Accordingly, the above problem does not occur.

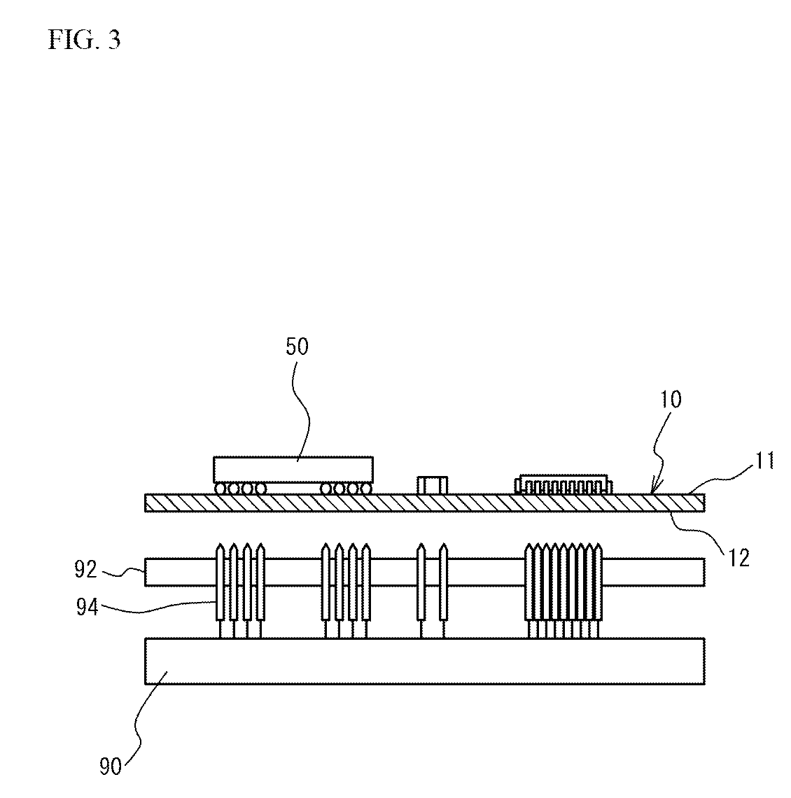

FIG. 3 is an explanatory view of a check test of the electrical operation. A test device 90 tests whether or not the object to be tasted is suitably conductive or is insulated. The test device 90 is electrically connected to a pin board 92. The pin board 92 is provided with plural probe pins 94.

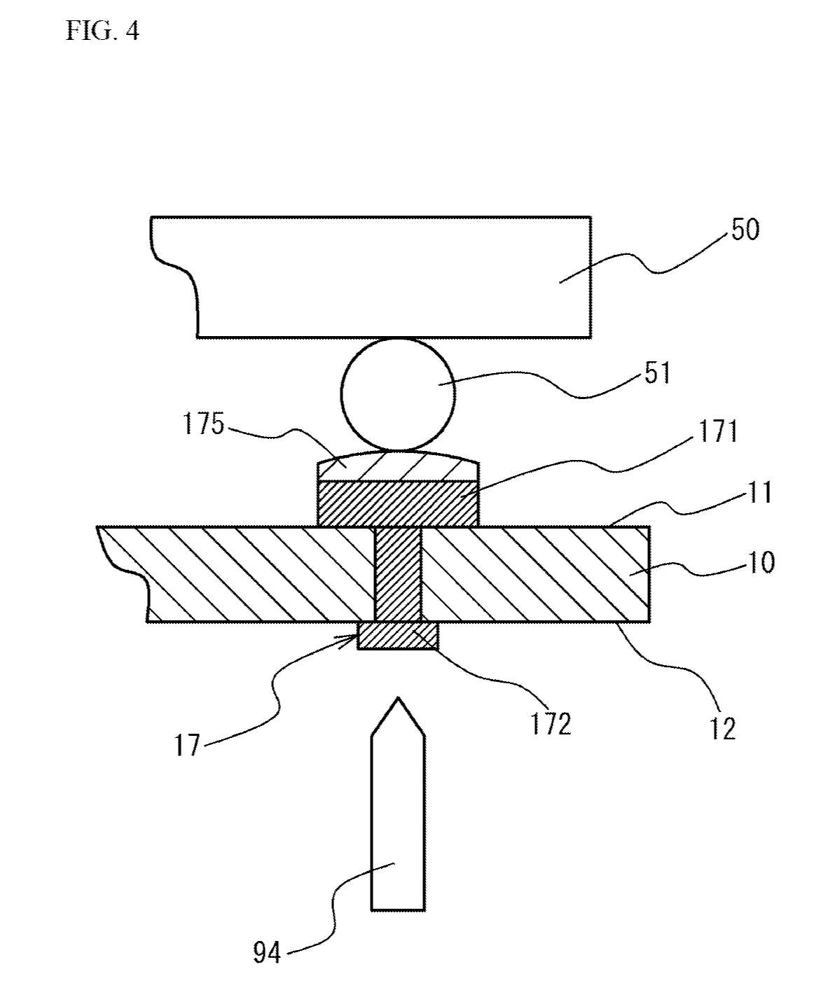

FIG. 4 is an explanatory view of the connection of the base substrate 10 to the probe pin 94. The electronic part 50 is a BGA type, and is mounted on the base substrate 10. Additionally, the electronic part 50 may be an LGA type. The electronic part 50 has a solder bump 51. A substrate electrode 17 penetrates through the base substrate 10. A solder 175 is printed on an electrode end 171 of the substrate electrode 17. The solder 175 and the solder bump 51 are melted by reflow soldering, so that the electronic part 50 and the base substrate 10 are electrically connected to each other. By abutting one end of the probe pin 94 with an electrode end 172 of the substrate electrode 17, the check test of the electrical operation of the base substrate 10 is performed. This tests whether or not the electronic part 50 is normally mounted on the base substrate 10. In this manner, the substrate electrode 17 penetrates through the base substrate 10, thereby testing the electrical connection of the substrate and the electronic part such as the BGA type or LGA type.

As illustrated in FIG. 4, the substrate electrode 17 also has the electrode end 171 provided on the first surface 11 and the electrode end 172 provided on the second surface 12. This suppresses a difference in the metal amount between on the first surface 11 side and on the second surface 12 side. When the base substrate 10 is exposed to high-temperature environment such as the reflow soldering, the base substrate 10 may be curved by the difference in thermal expansion coefficient between the insultive layer and the conductive layer. However, the difference in the amount of metal between on the first surface 11 side and on the second surface 12 side is suppressed, thereby suppressing the base substrate 10 from being curved.

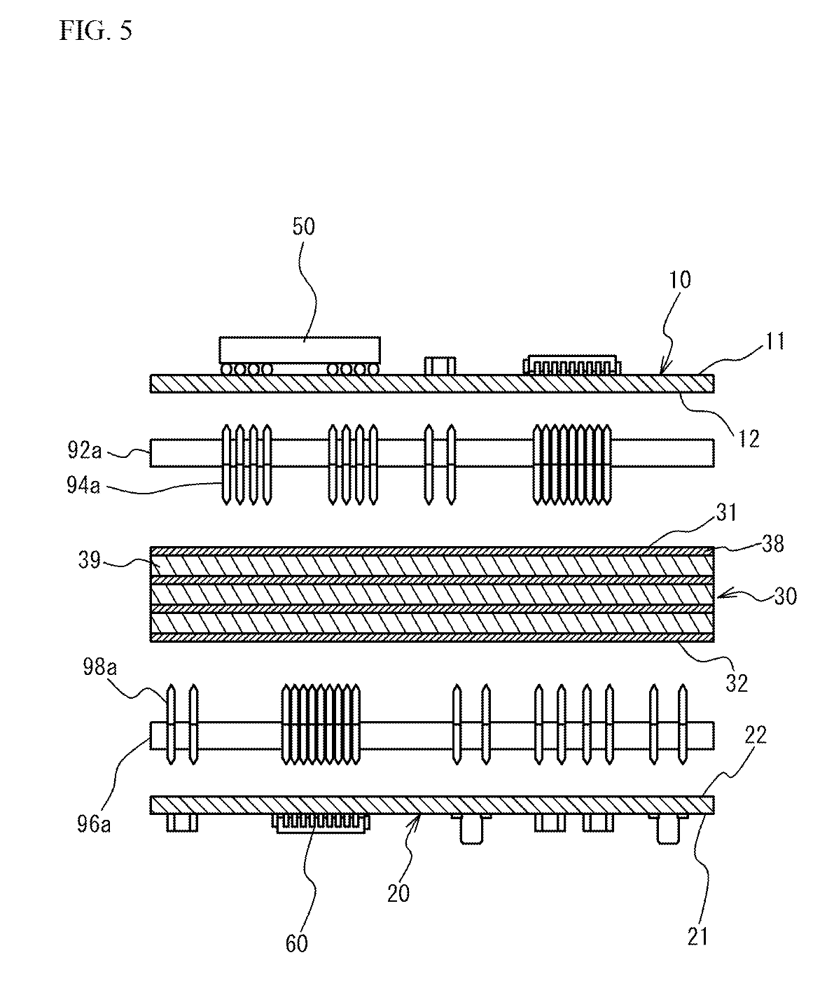

FIG. 5 is an explanatory view of a check test of the electrical operation. A pin board 92a is arranged between the base substrate 10 and the inner substrate 30, and a pin board 96a is arranged between the inner substrate 30 and the base substrate 20. One end of the probe pin 94a of the pin board 92a is connected to an electrode of the base substrate 10 side, and the other end of the probe pin 94a is connected to an electrode of the inner substrate 30 side. Further, one end of a probe pin 98a is connected to an electrode of the base substrate 20 side, and the other end of the probe pin 98a is connected to an electrode of the inner substrate 30 side. This situation allows the electrical operation of the entirety of the electronic part unit to be tested.

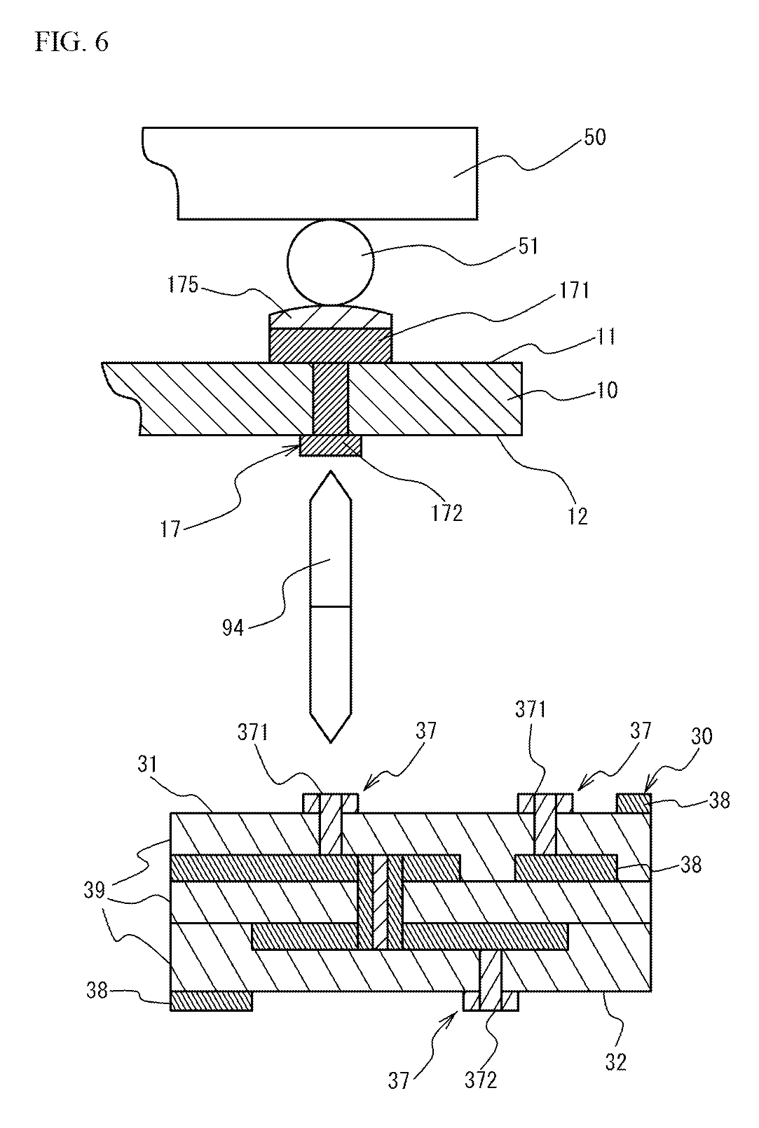

FIG. 6 is an explanatory view of the connection of the base substrate 10, the inner substrate 30 and the probe pin 94a. Plural substrate electrodes 37 are provided on the first surface 31 of the inner substrate 30. The substrate electrode 37 includes an electrode end 371 arranged on the first surface 31 side of the inner substrate 30 and an electrode end 372 arranged on the second surface 32 side of the inner substrate 30. The electrode ends 371 and 372 are electrically connected to each other via the copper layers 38 or the like within the inner substrate 30. The electrode ends 172 and 371 are connected via the probe pin 94a, thereby testing the operation of the base substrate 10 and the inner substrate 30. Thus, the test can be performed before the base substrates 10 and 20 are adhered to the inner substrate 30.

### Second Embodiment

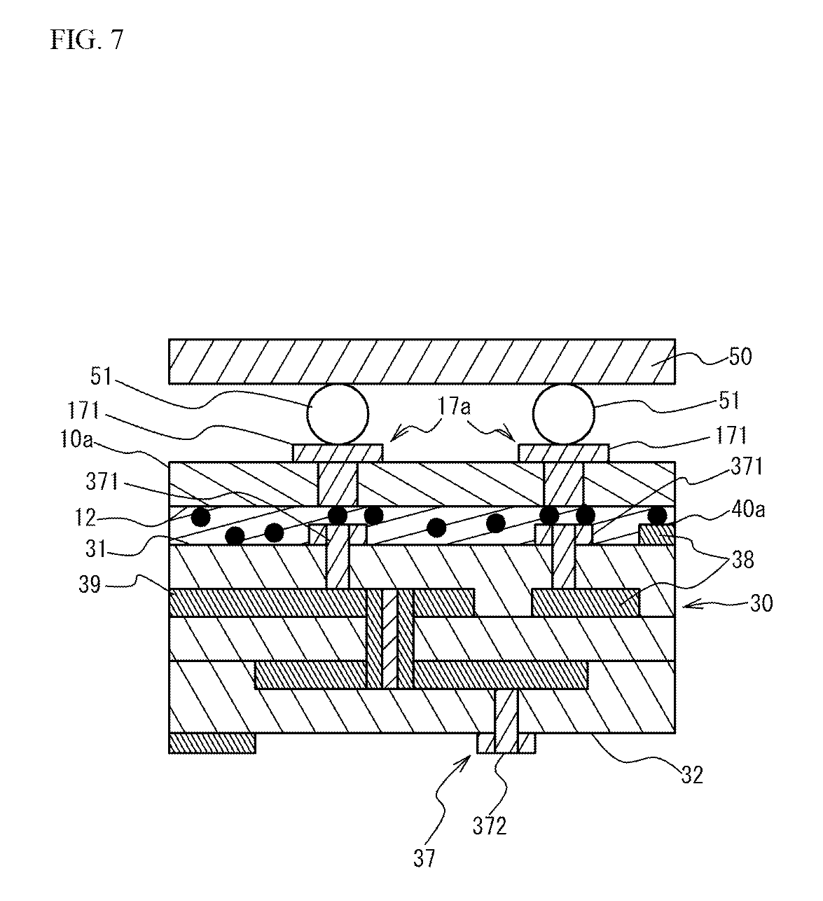

FIG. 7 is an explanatory view of an electronic part unit according to the second embodiment. Additionally, the base substrate 20 side is omitted in FIG. 7. Although a substrate electrode 17a includes the electrode end 171 arranged on the first surface 11 side of the base substrate 10, the substrate electrode 17a is not projected from the second surface 12 of the base substrate 10. The base substrate 10 and the inner substrate 30 are adhered by an adhesive member 40a. The adhesive member 40a is anisotropic bonding agent with conductivity, thermosetting property, and a paste form. Specifically, the adhesive member 40a is made of a bond with insulation property and plural particles with conductivity mixed into the bond. For these reasons, even when the substrate electrode 17a and the electrode end 371 are indirectly contact with each other, the conductive particles ensure the electrical connection between the base substrate 10 and the inner substrate 30, having a narrow clearance therebetween.

### Third Embodiment

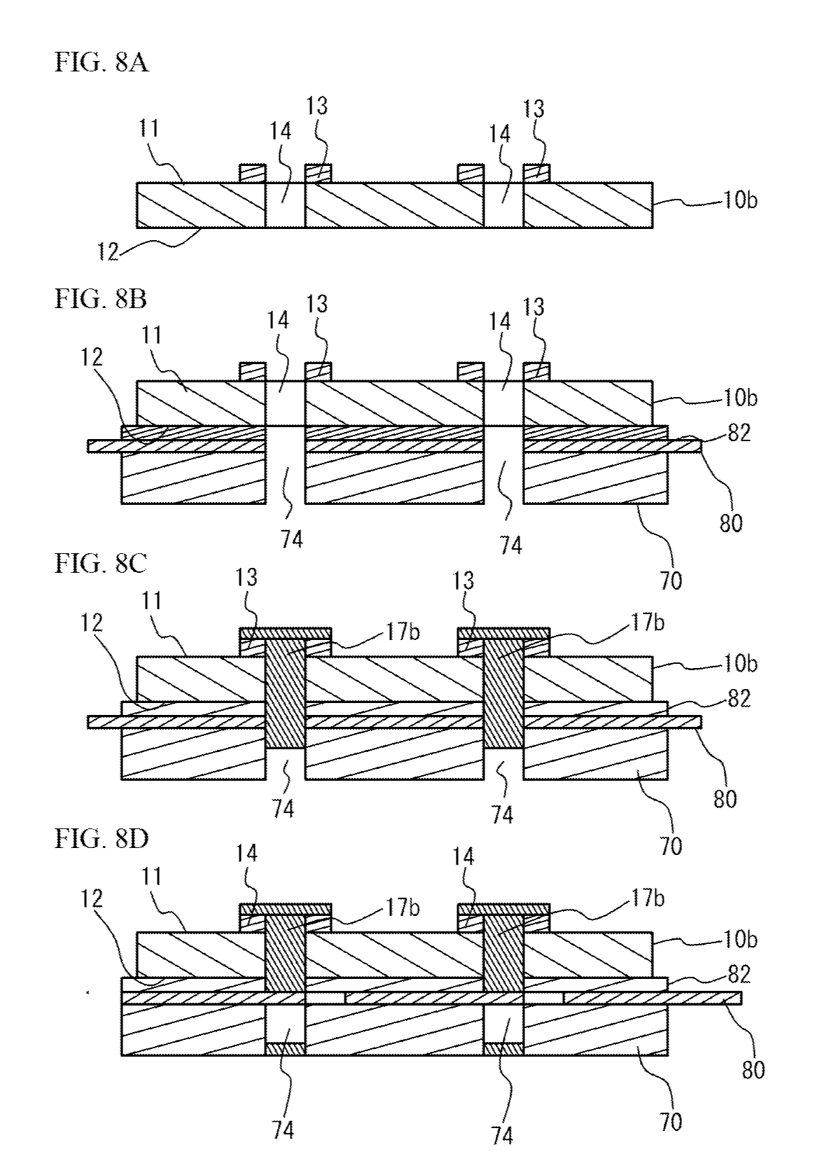

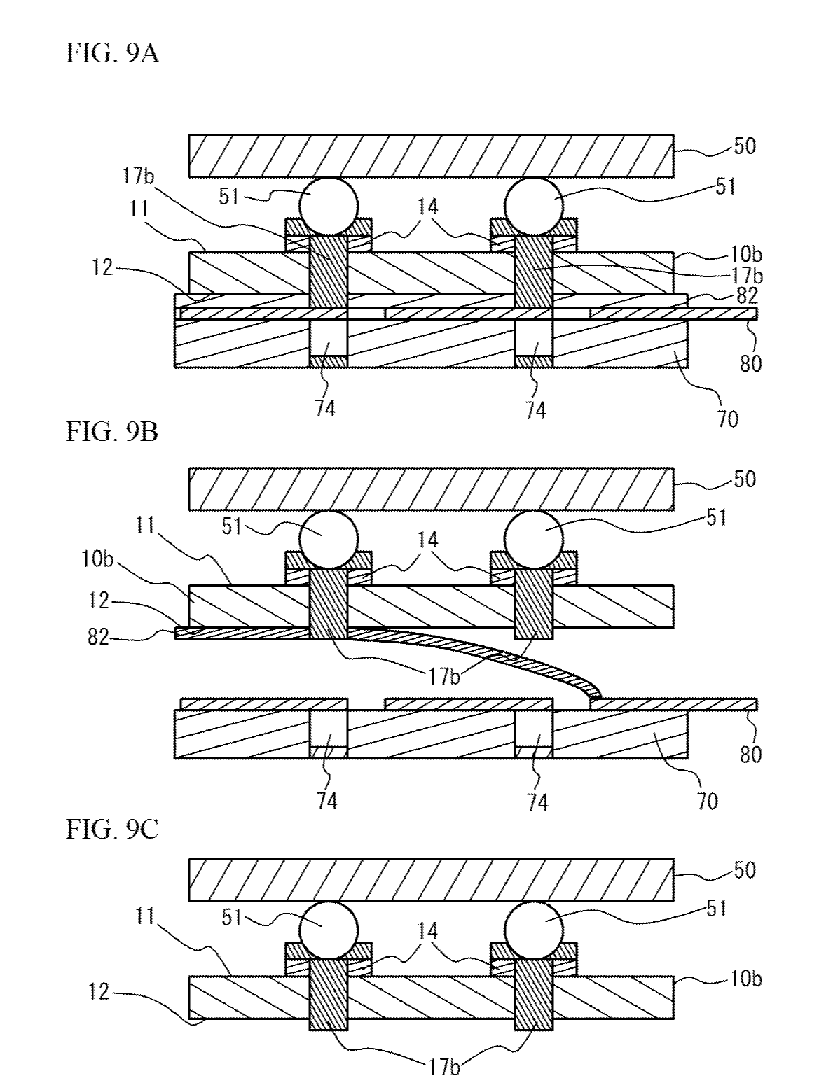

FIGS. 8A to 8D, and 9A to 9C are explanatory views of an electronic part unit according to the third embodiment. As illustrated in FIG. 8A, the base substrate 10b has through holes 14. Foot patterns 13 are formed in the periphery of the through holes 14 on the first surface 11. As illustrated in FIG. 8B, a support member 70, heat-resistant films 80 and 82 are arranged at the second surface 12 side of the base substrate 10b. The support member 70 has through holes 74 corresponding to the through holes 14. Also, the heat-resistant films 80 and 82 each has holes corresponding to the through holes 14. An adhesive material is applied to the heat-resistant film 82 at the second surface 12 side of the base substrate 10b. The heat-resistant film 82 is pasted on the second surface 12 of the base substrate 10b.

As illustrated in FIG. 8C, a conductive paste 17b is applied to the surface of the foot pattern 13 and within the through hole 14. As a method for applying the conductive paste 17b, there is squeegee printing or dip applying, for example. The conductive paste 17b flows within the through hole 14 to reach the second surface 12 side of the base substrate 10b. Next, as illustrated in FIG. 8D, only the heat-resistant film 80 arranged between the heat-resistant film 82 and the support member 70 is displaced. Therefore, low ends of the conductive paste 17b are cut out. This causes the conductive paste 17b to have a shape projecting from the second surface 12 side of the base substrate 10b.

Next, the electronic part 50 is mounted on the first surface 11 of the base substrate 10b. Specifically, as illustrated in FIG. 9A, solder bumps 51 of the electronic part 50 are arranged on the through holes 14 by a mounting device, and then the reflow soldering is performed in this state. The solder bump 51 and the conductive paste 17b are melted by the reflow soldering. Then they are cooled, the solder bump 51 is connected to the foot pattern 13 and the conductive paste 17b. Next, as illustrated in FIG. 9B, the base substrate 10b is removed from the heat-resistant film 82. In this manner, there is formed the substrate electrode having its end projecting from the second surface 12 side of the base substrate 10b, as illustrated in FIG. 9C. The conductive paste 17b corresponds to a substrate electrode. Further, the step for forming the substrate electrode corresponds to an electrode forming step.

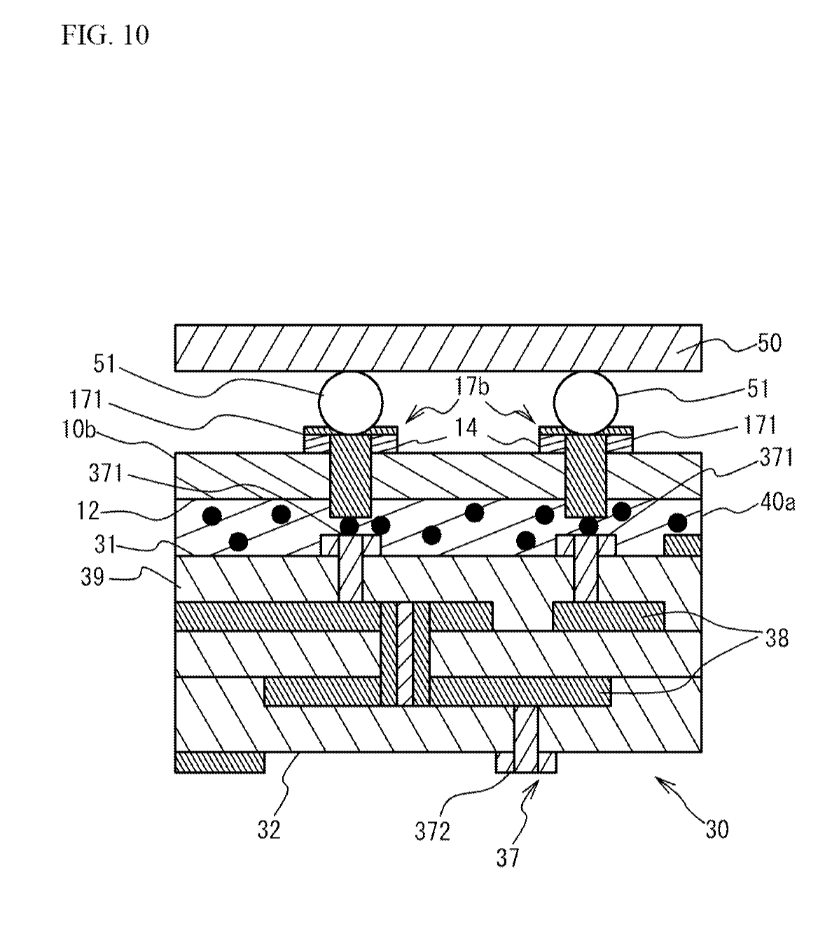

FIG. 10 is an explanatory view of the inner substrate 30. As illustrated in FIG. 10, the electrode end 371 of the substrate electrode 37 is formed on the first surface 31 of the inner substrate 30. The electrode end 372 of the substrate electrode 37 is formed on the second surface 32 of the inner substrate 30. The electrode ends 371 and 372 are formed by plating. Next, the second surface 12 of the base substrate 10b is adhered to the first surface 31 of the inner substrate 30 by the adhesive member 40a. The adhesive member 40a is anisotropic bond with conductivity, thermosetting property, and a paste form. In this process, even when the low end of the conductive paste 17b is not brought into contact with the electrode end 371, the electrical connection is ensured by the adhesive member 40a, as described in the second embodiment. Further, the clearance between the conductive paste 17b and the electrode end 371 is smaller than that described in the second embodiment, thereby ensuring the electrical connection with certainty. Furthermore, the clearance between the electrodes to be connected is small, whereby the diameter of the conductive particle is made small. This suppresses short circuit, even when a clearance between electrodes that should not to be connected is small.

### Fourth Embodiment

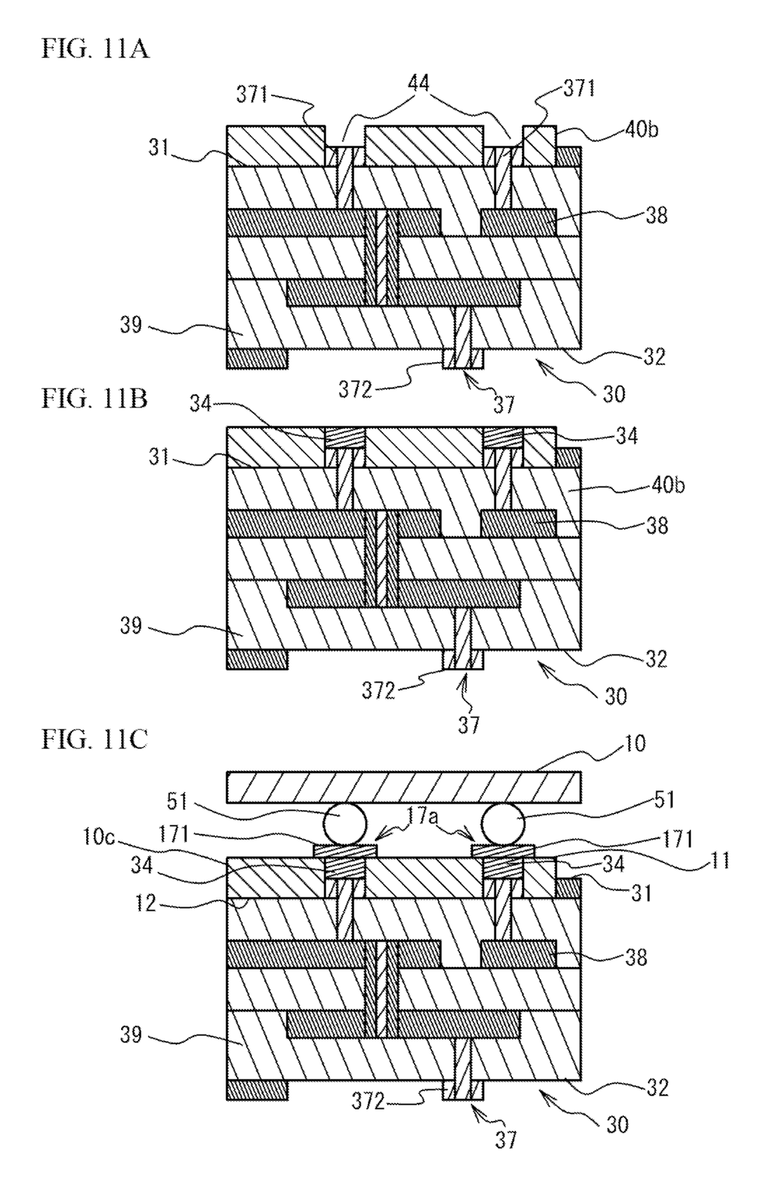

FIGS. 11A to 11C are explanatory views of a method for producing an electronic part unit according to the fourth embodiment. As illustrated in FIG. 11A, an adhesive member 40b is adhered to the first surface 31 of the inner substrate 30. The adhesive member 40b has holes 44 for exposing the electrode end 371 of the substrate electrode 37 arranged at the first surface 31 side. As illustrated in FIG. 11B, a conductive paste 34 is applied to parts where the holes of the adhesive member 40b are formed, that is, to the electrode ends 371 of the substrate electrode 37. As illustrated in FIG. 11C, the second surface 12 of a base substrate 10c is attached to the first surface 31 of the inner substrate 30 such that the ends of the substrate electrode 17a at the second surface 12 are brought into contact with the conductive paste 34. The conductive paste 34 ensures the electrical connection between the base substrate 10c and the inner substrate 30. It is also possible to ensure the contact area between the conductive paste 34 and the substrate electrode 17a, and that between the conductive paste 34 and the substrate electrode 37.

### Fifth Embodiment

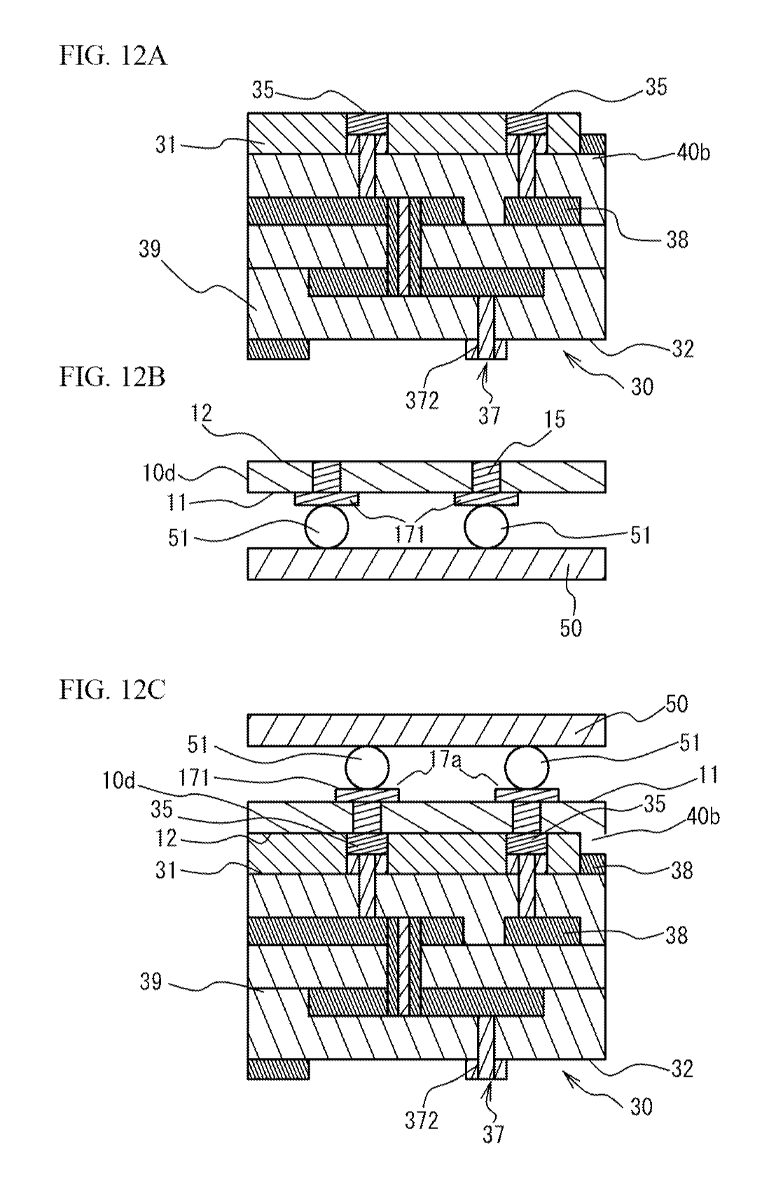

FIGS. 12A to 12C are explanatory views of a method for producing an electronic part unit according to the fifth embodiment. As illustrated in FIG. 12A, solder 35 is applied within the holes of the adhesive member 40b. The melting point of the solder 35 is about 120 degrees. The method for applying the solder 35 is, for example, an ink jet method, or a solder printing method. Next, as illustrated in FIG. 12B, solder 15 is applied to through holes formed in a base substrate 10d with the base substrate 10d reversed. The above described method for applying solder is also applied to the method for applying the solder 15. Additionally, the electrode end 171 which covers the through hole is provided at the first surface 11 side in the base substrate 10d. Then, as illustrated in FIG. 12C, the base substrate 10d is attached to the inner substrate 30 such that the solder 35 correspond to the solder 15, and are then heated. This melts and joints the solder 35 and the solder 15.

### Sixth Embodiment

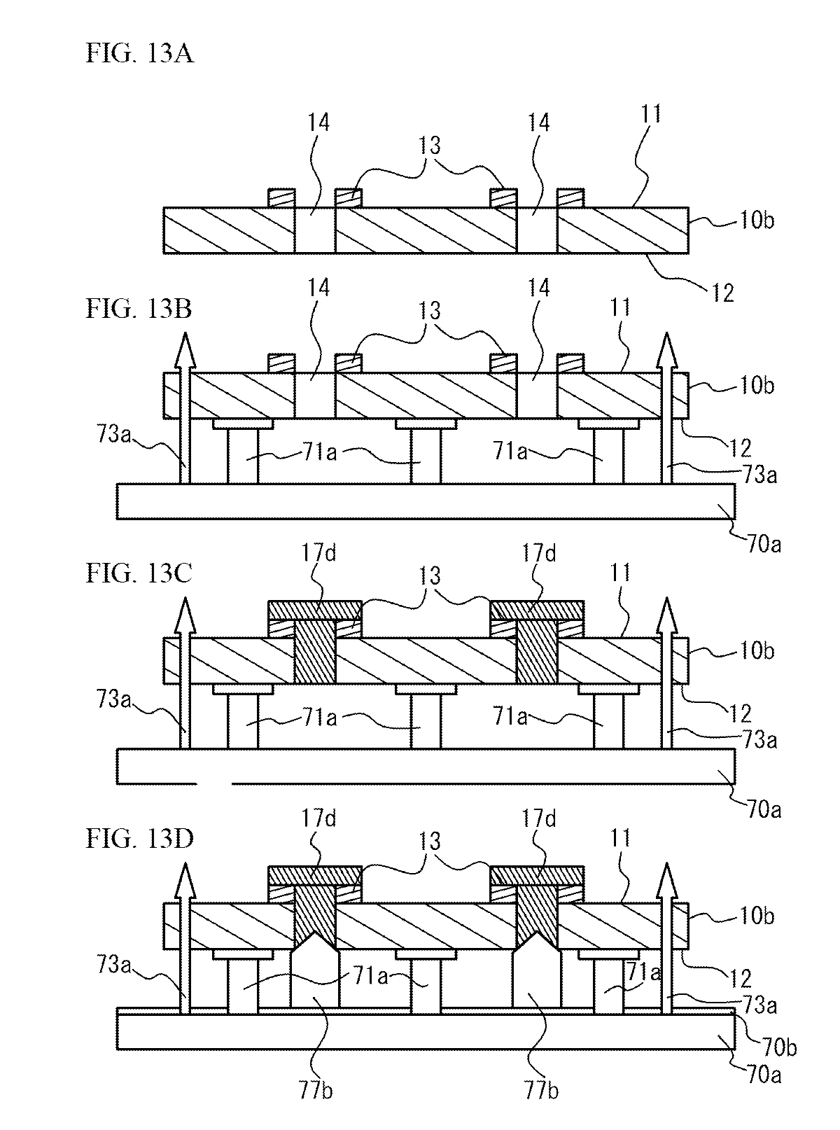

FIGS. 13A to 13D, 14A, 14B, 15A and 15B are explanatory views of a method for producing an electronic part unit according to the sixth embodiment. As illustrated in FIGS. 13A and 13B, the base substrate 10b is arranged on a support member 70a. The support member 70a is provided with support pins 71a for supporting the second surface 12 of the base substrate 10b. The support member 70a is also provided with positioning pins 73a for positioning the base substrate 10b. Additionally, the positioning pin 73a has an end portion with an anchor shape for holding the first surface 11 side of the base substrate 10b. Accordingly, the support pins 71a and the positioning pins 73a suppress the curving of the base substrate 10b when reflowed, as mentioned later. Next, as illustrated in FIG. 13C, a conductive paste 17d is applied within the through hole 14 and to the upper surfaces of the foot patterns 13. Then, the base substrate 10b is removed from the support member 70a, a jig 70b is arranged on the support member 70a, and the base substrate 10b is again attached on the support member 70a, as illustrated in FIG. 13D. The jig 70b is provided with pins 77b at its positions corresponding to the through holes 14. The pin 77b has an end with a circular cone shape. By inserting the end of the pin 77b into the through hole 14, the through hole 14 is deaerated.

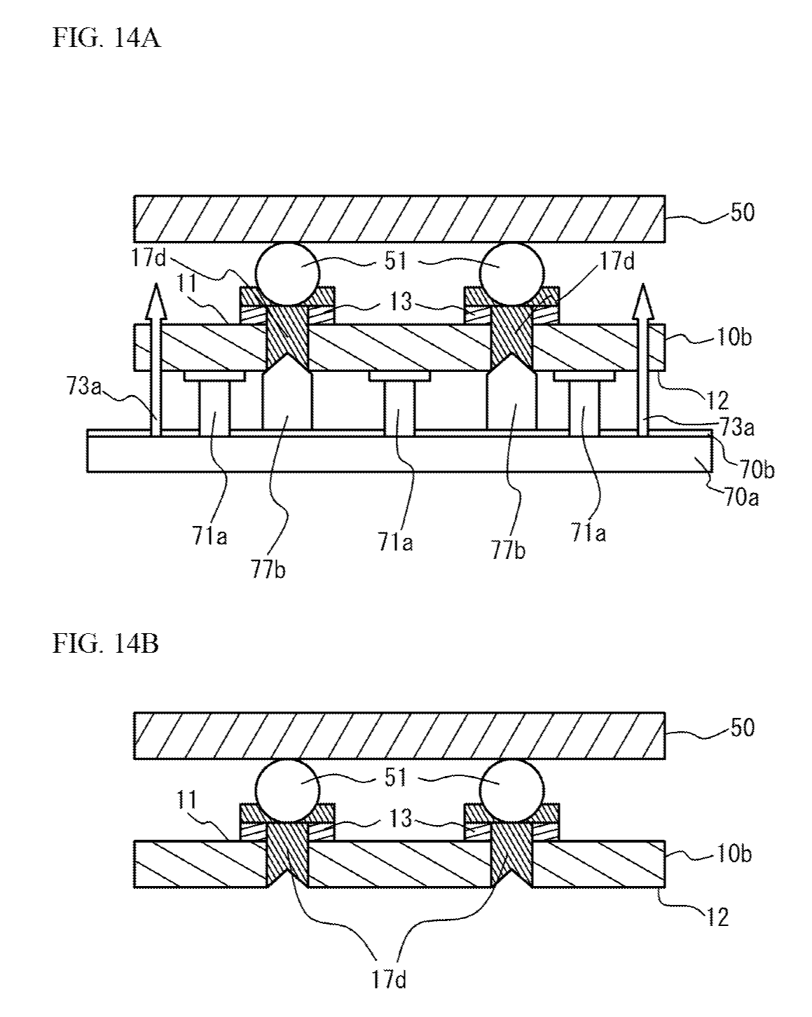

Next, as illustrated in FIG. 14A, the electronic part 50 is arranged on the base substrate 10b, and is then reflowed. This melts and electrically connects the solder bump 51 and the conductive paste 17d. Then, as illustrated in FIG. 14B, when the support member 70a and the jig 70b are removed from the base substrate 10b, the end portion of the second surface 12 of the conductive paste 17d has a conical recess shape.

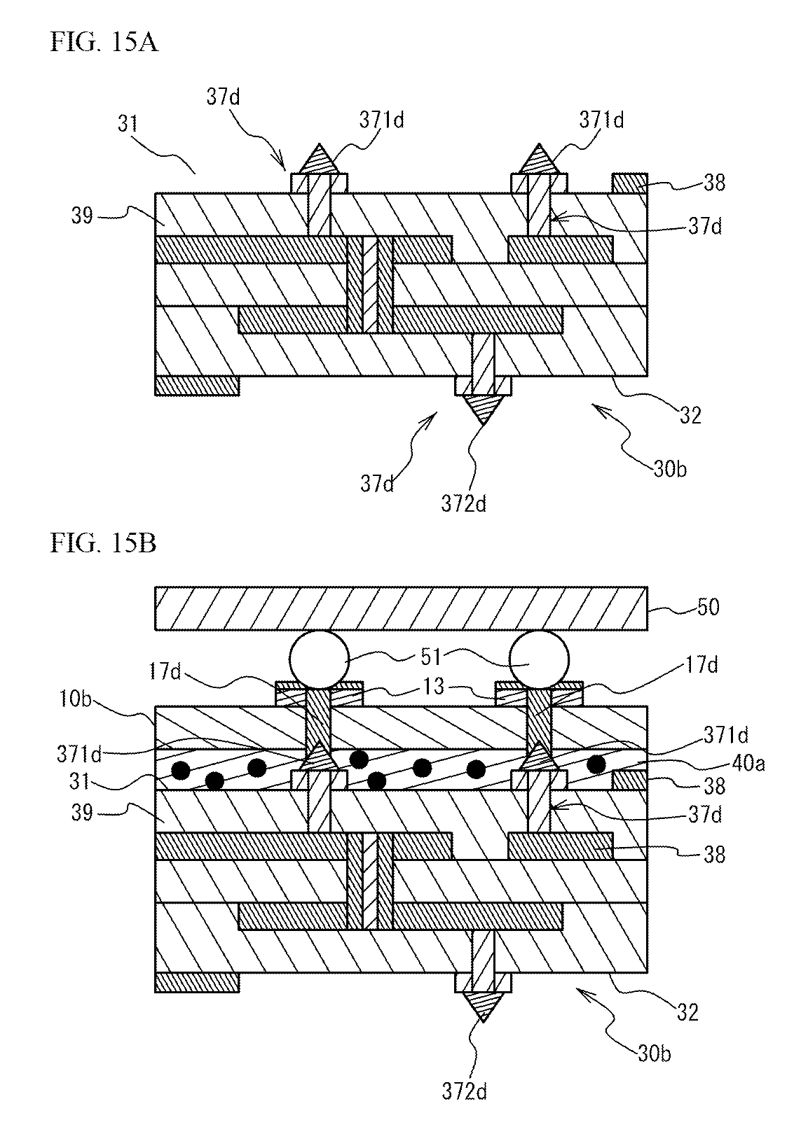

As illustrated in FIG. 15A, substrate electrodes 37d of an inner substrate 30b have electrode ends 371d and 372d. The electrode ends 371d and 372d each has a conical projection shape. The electrode ends 371d and 372d are formed by plating. As illustrated in FIG. 15B, the base substrate 10b is adhered to the inner substrate 30b such that the electrode end 371d engages the low ends of the conductive paste 17d. The electrode end 371d and the conductive paste 17d each has a complementary shape, thereby improving the alignment and the electrical connection.

### Seventh Embodiment

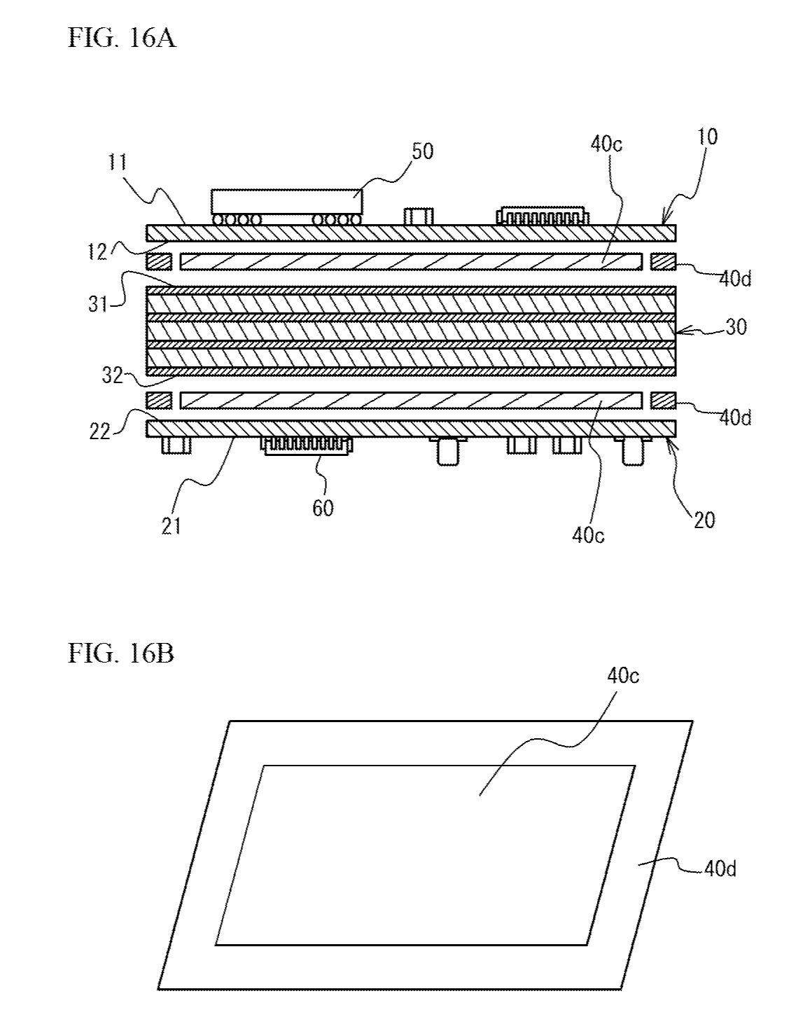

FIGS. 16A and 16B are explanatory views of an electronic part unit according to the seventh embodiment. As illustrated in FIG. 16A, the base substrate 10 and the inner substrate 30 are adhered by adhesive members 40c and 40d. As illustrated in FIG. 16B, the adhesive member 40d is arranged at the outside to have a frame shape, and the adhesive member 40c is arranged at the center of the frame. The adhesive members 40c and 40d each has a sheet shape. The adhesive members 40c and 40d are thermoset adhesive materials. The fluidity of the adhesive member 40d is lower than that of the adhesive member 40c. This prevents the adhesive member 40c from flowing out of an edge or the like of the base substrate 10 when thermally hardened. Additionally, an adhesive bond having a low fluidity is inexpensive. For this reason, the manufacturing cost is suppressed.

### Eighth Embodiment

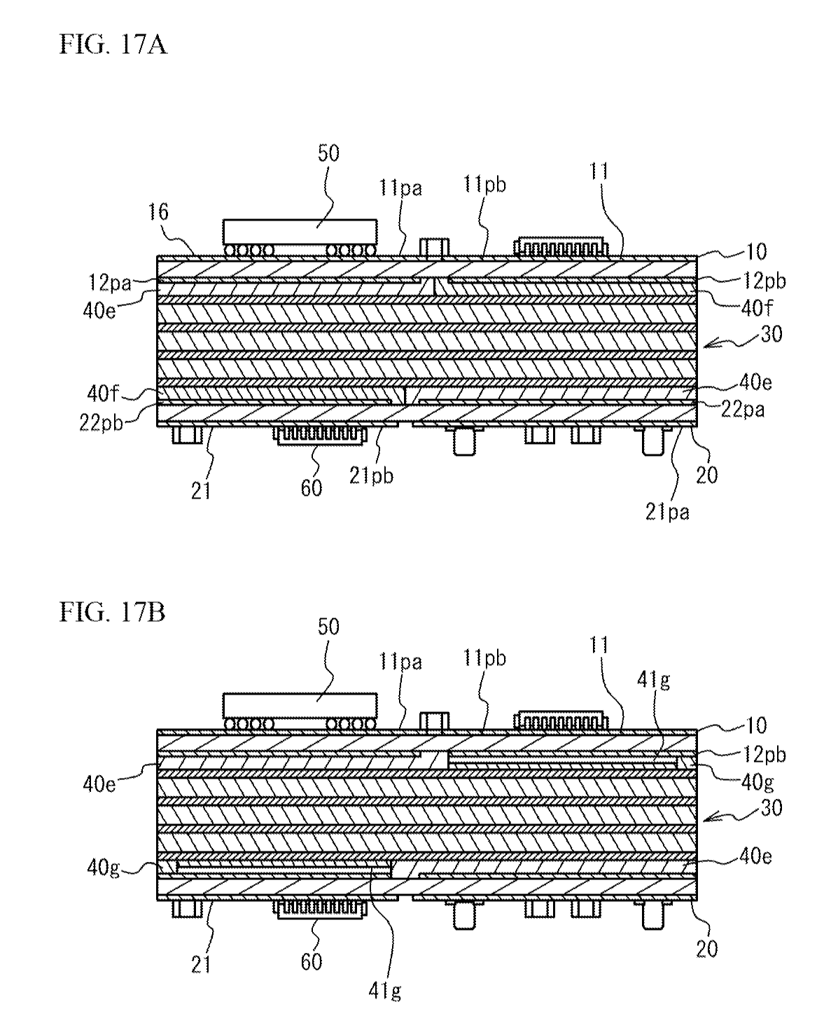

FIGS. 17A and 17B are explanatory views of an electronic part unit according to the eighth embodiment. As illustrated in FIG. 17A, the base substrate 10 and the inner substrate 30 are adhered by adhesive members 40e and 40f. The adhesive member 40e includes a material component different from that of the adhesive member 40f. The adhesive members 40e and 40f each has an insulating property. Wiring patterns 11pa and 11pb, which respectively correspond to the electronic parts 50, are formed on the first surface 11 of the base substrate 10. Likewise, wiring patterns 12pa and 12pb are formed on the second surface 12 of the base substrate 10.

The adhesive member 40e is adhered to the wiring pattern 12pa, and the adhesive member 40f is adhered to the wiring pattern 12pb. In this manner, since the adhesive members 40e and 40f are different in the material, they are different in the dielectric constant. Impedances of alternating currents flowing in the wiring patterns 12pa and 12pb are changed with the influence of the dielectric constants of the adhesive members 40e and 40f. Therefore, the impedance is adjustable by changing the material of the adhesive member. Additionally, although the technique for adjusting impedance is achieved by adjusting a width or a thickness of a pattern, the design for a pattern has many restrictions.

Further, the method for adjusting the impedance is also achievable as follows. As illustrated in FIG. 17B, an adhesive member 40g is provided with a recess portion 41g. The recess portion 41g causes a part of the wiring pattern 12pb not to be in contact with the adhesive member 40g. The impedance is also adjustable in this way.

### Ninth Embodiment

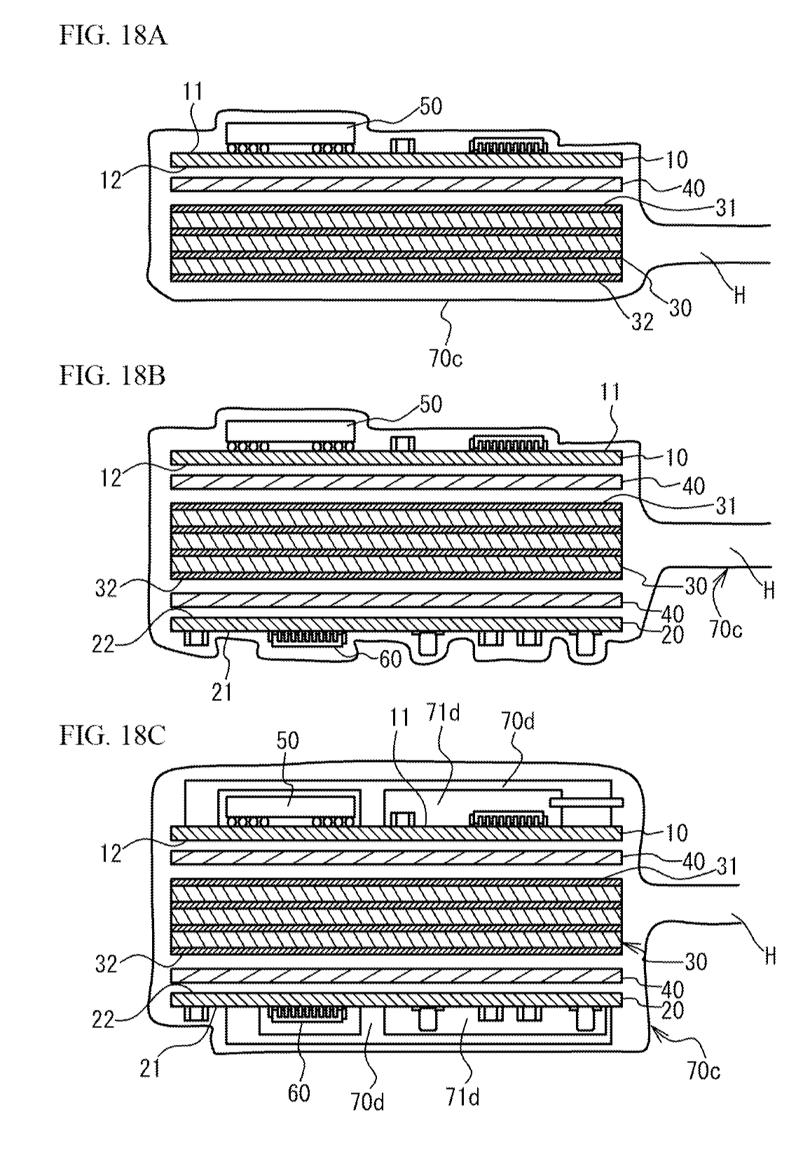

FIGS. 18A to 18C are explanatory views of a method for the adhesion of an electronic part unit according to the ninth embodiment. As illustrated in FIG. 18A, the base substrate 10 and the inner substrate 30 are temporarily adhered with the adhesive member 40, and then the entire of the base substrate 10, the inner substrate 30 and the adhesive member 40 is covered by a heat-resistant sheet 70c. The heat-resistant sheet 70c corresponds to a cover member. The heat-resistant sheet 70c has a pouch shape. The heat-resistant sheet 70c is made of, for example, a polyimide resin. Next, the entire of the heat-resistant sheet 70c is heated while being vacuumed from the opening H by a pump or the like. The heating temperature is about 120 degrees. The heating enables the base substrate 10 and the inner substrate 30 to be adhered to each other. Then, the second surface 32 of the inner substrate 30 is temporally adhered to the base substrate 20, and the base substrates 10 and 20 and the inner substrate 30 are heated while the heat-resistant sheet 70c being vacuumed. This removes air between the base substrate 10 and the inner substrate 30, and air between the base substrate 20 and the inner substrate 30. Accordingly, the adhesiveness between the base substrates 10 and 20, and the inner substrate 30 can be improved.

In addition, as illustrated in FIG. 18C, the vacuuming and the heating may be performed while the base substrates 10 and 20 are being pushed toward the inner substrate 30 side by a press jig 70d. This further improves the adhesiveness. The press jig 70d has recess portions 71d for preventing the interference with the electronic parts 50 and 60. The press jig 70d is made of, for example, a metal. The press jig 70d facilitates the pressing of the base substrates 10 and 20. This improves the adhesiveness between the base substrates 10 and 20, and the inner substrate 30. Moreover, the press jig 70d has a function for protecting the electronic parts 50 and 60 when the base substrates 10 and 20 are dropped.

### Tenth Embodiment

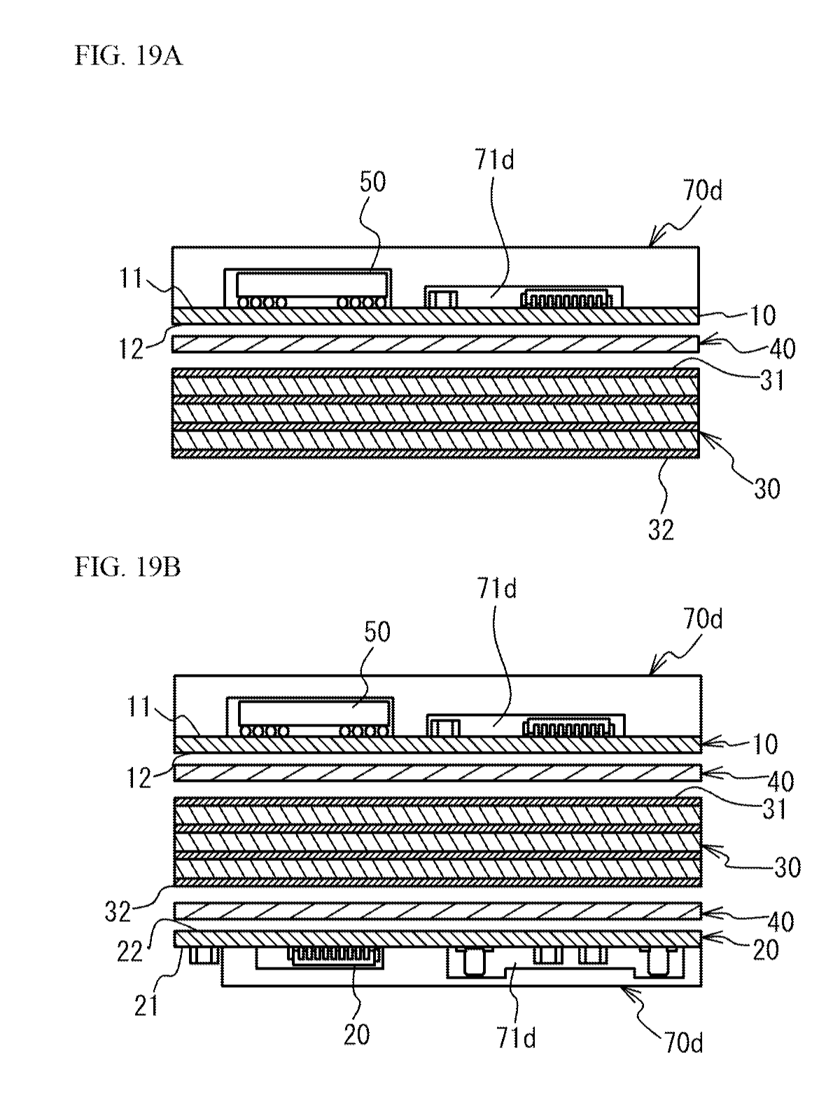

FIGS. 19A and 19B are explanatory views of a method for adhesion of an electronic part unit according to the tenth embodiment. As illustrated in FIG. 19A, a press jig 70d is arranged on the first surface 11 side of the base substrate 10, and then the base substrate 10 is heated, with pressed toward the inner substrate 30 by the press jig 70d. In this manner, the base substrate 10 is adhered to the inner substrate 30. Next, as illustrated in FIG. 19B, the press jig 70d is arranged on the first surface 21 side of the base substrate 20. The base substrates 10 and 20 are heated with pressed toward the inner substrate 30. Thus, the base substrate 20 and the inner substrate 30 are adhered to each other. In addition, the base substrates 10 and 20 may simultaneously be adhered to the inner substrate 30. That is, the base substrates 10 and 20 supported by the press jig 70d are heated with pressed toward the inner substrate 30, thereby adhering the base substrates 10 and 20 to the inner substrate 30 at one step.

### Eleventh Embodiment

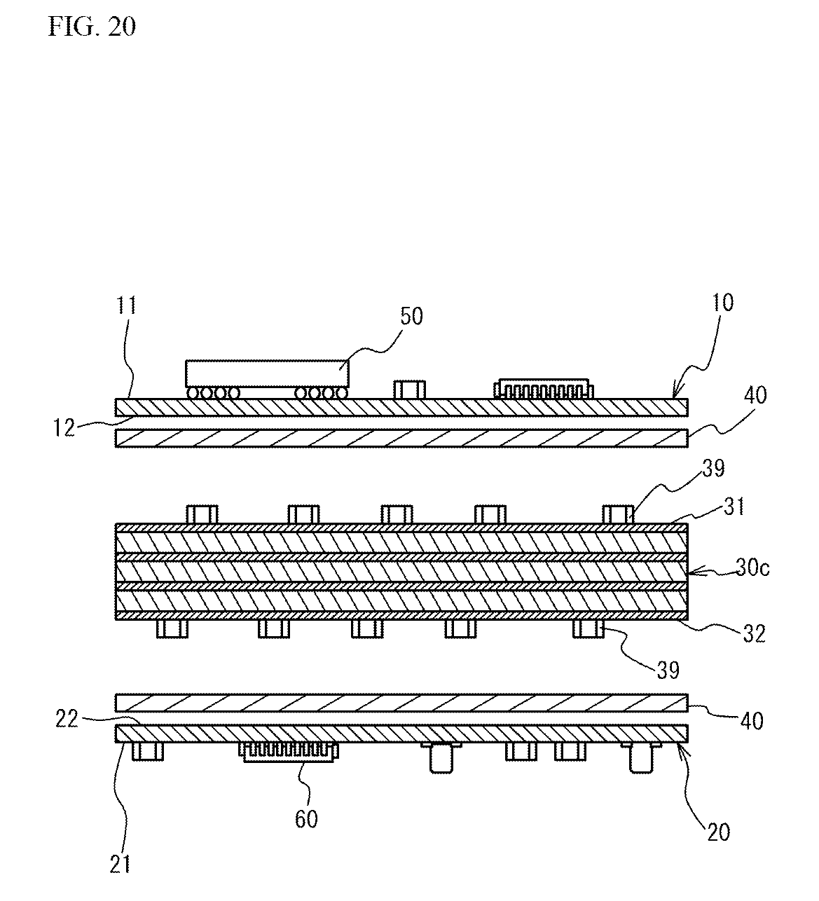

FIG. 20 is an explanatory view of an electronic part unit according to the eleventh embodiment. Electronic parts 39 are mounted on the first surface 31 and the second surface 32 of the inner substrate 30. The electronic parts 39 are comparatively small parts such as a condenser or a resistor. In this way, the inner substrate 30c on which the electronic parts 39 are mounted may be used. Further, in the adhesive member 40, a hole is provided for avoiding the interference with the electronic parts 39. Furthermore, the adhesive member 40 is provided to avoid interfering with the patterns formed on the second surface 12 of the base substrate 10 or the second surface 22 of the base substrate 20.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the sprit and scope of the invention.

What is claimed is:

1. A method for producing an electronic part unit, the method comprising:
mounting a first electronic part on a first surface of a first substrate by reflow soldering;
mounting a second electronic part on a second surface of a second substrate by reflow soldering;
adhering a second surface of the first substrate to a first surface of a third substrate; and
adhering a second surface of the second substrate to a second surface of the third substrate.

2. The method for producing the electronic part unit of claim 1, further comprising forming a first substrate electrode for electrically connecting an electrode of the first electronic part on the second surface of the first substrate.

3. The method for producing the electronic part unit of claim 2, wherein the first substrate electrode projects from the first and second surfaces of the first substrate.

4. The method for producing the electronic part unit of claim 2, further comprising forming an electrode having a projection shape in such a position where the first substrate electrode of the third substrate is adhered,
wherein the first electrode has a recess shape when viewed from the second surface side from the first substrate.

5. The method for producing the electronic part unit of claim 1, wherein the adhering the second surface of the first substrate to the first surface of the third substrate comprises:
attaching an adhesive member having a sheet shape on the first substrate in such a position to avoid an interference with an electrode electrically connected to a first substrate electrode; and
providing a conductive member in the electrode.

6. The method for producing the electronic part unit of claim 1, wherein the adhering the second surface of the first substrate to the first surface of the third substrate comprises adhering the first substrate to the third substrate by using an adhesive member having a sheet shape, an insulative property, and a recess portion for avoiding an interference with a part of the first substrate.

7. The method for producing the electronic part unit of claim 1, wherein the adhering the second surface of the first substrate to the first surface of the third substrate comprises: adhering the first substrate to the third substrate by using a plurality of adhesive members each having a different material and a sheet shape.

8. The method for producing the electronic part unit of claim 1, wherein the adhering the second surface of the first substrate to the first surface of the third substrate comprises:
arranging an adhesive member with low fluidity on an outside of the second surface of the first substrate or the first surface of the third substrate; and
arranging an adhesive member with high fluidity on the inside of the second surface of the first substrate or the first surface of the third substrate.

9. The method for producing the electronic part unit of claim 1, wherein the adhering the second surface of the first substrate to the first surface of the third substrate comprises:
covering the first and third substrates by a cover member having a pouch shape;
vacuuming an inside of the cover member; and
performing a reflow soldering after that the vacuuming.

10. The method for producing the electronic part unit of claim 1, wherein the adhering the second surface of the first substrate to the first surface of the third substrate comprises:
securing a press jig on the first surface of the first substrate to surround the first electronic part; and
pressing the first substrate to the third substrate by pressing the press jig.
